(19) United States
(12) Patent Application Publication
(10) Pub. No.: US 2017/0087747 A1
(43) Pub. Date: Mar. 30, 2017

(54) MANUFACTURE METHOD OF LIQUID EJECTION HEAD

(71) Applicant: CANON KABUSHIKI KAISHA, Tokyo (JP)

(72) Inventors: Tetsushi Ishikawa, Tokyo (JP); Tamaki Sato, Kawasaki-shi (JP); Masafumi Morisue, Tokyo (JP)

(21) Appl. No.: 15/266,117

(22) Filed: Sep. 15, 2016

(30) Foreign Application Priority Data
Sep. 28, 2015 (JP) 2015-189646

(51) Int. Cl. B29C 35/08; B29C 65/48; B41J 2/16

(52) U.S. Cl. CPC B29C 35/0805; B41J 2/1637; B29C 65/48; B29C 2035/0827; B29L 2031/757

(57) ABSTRACT

A mold unit and base units are formed on a substrate. A covering resin layer is formed by coating a liquid-like resin composition to cover the surfaces of the mold unit and the base unit. When interval between one end of the base unit and the mold unit adjacent thereto is δ1, the interval of the plurality of base units is δ2, a distance between the center of the ejection opening and the other end of the base unit is L, the height of the unevenness between the surface of the base unit and the surface of the mold unit is ΔH, and the covering resin layer has a thickness H2, when the base unit is established to δ2≦30 μm, the base unit and the covering resin layer are formed so that the relations δ1≦30 μm and ΔH=0 μm or H2/ΔH≧3 are satisfied.

### BACKGROUND OF THE INVENTION

Field of the Invention

The present invention relates to a method of manufacturing a liquid ejection head to eject liquid through an ejection opening.

Description of the Related Art

A liquid ejection head used for an inkjet print apparatus is configured so that an orifice plate including a plurality of ejection openings and a flow path is provided on a substrate consisting of silicon for example having thereon an ejection energy generation element for ejecting liquid for example. Methods of manufacturing this liquid ejection head include a known method to form a pattern for forming a flow path on the substrate by a dissolvable resin layer. Then, a covering resin layer functioning as an orifice plate is formed on the pattern after which the pattern is dissolved and removed to thereby form the flow path.

Japanese Patent Laid-Open No. 2007-216630 discloses a technique regarding the manufacture method as described above in which, prior to the application of the covering resin to form the orifice plate, a mold unit for forming a flow path on the substrate is formed and a base unit is formed to surround the mold unit. By forming the base unit to surround the mold unit forming the flow path as described above, a situation can be suppressed in which the application of the covering resin causes the covering resin layer to have a reduced film thickness along the unevenness formed by the mold unit configuring the flow path and the substrate surface. Thus, the manufacture method according to Japanese Patent Laid-Open No. 2007-216630 suppresses the reduction of the distance between the ejection energy generation element and the ejection opening surface of the orifice plate (hereinafter referred to as an OH distance) and an extreme reduction of the orifice plate thickness. This can consequently improve the reliability of the liquid ejection head when compared with a case where no base unit is formed.

### SUMMARY OF THE INVENTION

The present invention provides a method of manufacturing a liquid ejection head in which an orifice plate having an ejection opening for ejecting liquid and a flow path communicating with the ejection opening is formed on a surface of a substrate, comprising: a first step of forming, on the surface of the substrate, a mold unit for forming the flow path and a plurality of base units including a base unit adjacent to the mold unit, and a second step of forming, on the surface of the substrate, a covering resin layer for forming the orifice plate by applying liquid-like resin composition so as to cover the surface of the mold unit and the surface of the base unit, in a case where in a direction parallel to the surface of the substrate, an interval between one end of the base unit and the mold unit adjacent thereto is δ1, the interval of the plurality of base units is δ2, a distance between the center of the ejection opening and the other end of the base unit is L, in a case where in a direction vertical to the surface of the substrate, the height of the unevenness caused between the surface of the base unit and the surface of the mold unit is ΔH, and a thickness of the covering resin layer is H2, when the base unit is formed so that δ2≦30 μm is established, the base unit and the covering resin layer are formed so that the relations δ1≦30 μm and ΔH=0 μm or H2/ΔH≧3 are satisfied and, when the base unit is formed so that δ2>30 μm is established, the base unit and the covering resin layer are formed so that the relations δ1≦30 μm, L≧300 μm and H=0 μm or H2/ΔH≧3 are satisfied.

Further features of the present invention will become apparent from the following description of exemplary embodiments (with reference to the attached drawings).

### BRIEF DESCRIPTION OF THE DRAWINGS

FIGS. 1A and 1B illustrate a part of a liquid ejection head manufactured by the manufacture method according to the present invention;

FIG. 2 is a schematic plan view illustrating the liquid ejection head manufactured by the first embodiment;

FIG. 3 is a plan view illustrating a wafer used in the present invention;

FIGS. 4A to 4F are a longitudinal cross-sectional side view schematically illustrating the respective manufacture steps in the first embodiment;

FIGS. 5A to 5D are a longitudinal cross-sectional side view schematically illustrating a part of the liquid ejection head;

FIG. 6 is a schematic plan view illustrating the first and second patterns in the first embodiment;

FIGS. 7A to 7F are a longitudinal cross-sectional side view schematically illustrating the respective manufacture steps in the second embodiment;

FIG. 8 is a schematic plan view illustrating the liquid ejection head manufactured by the second embodiment;

FIGS. 9A to 9G are a longitudinal cross-sectional side view schematically illustrating the respective manufacture steps in the third embodiment;

FIGS. 10A and 10B are a longitudinal cross-sectional side view schematically illustrating other embodiments of the present invention;

FIGS. 11A to 11G are a longitudinal cross-sectional side view illustrating the respective manufacture steps in Example 1; and

FIG. 12 is a longitudinal cross-sectional side view illustrating the positional relation between the base unit in the liquid ejection head and a mold unit.

### DESCRIPTION OF THE EMBODIMENTS

When a base unit is provided at the outer periphery of the mold unit functioning as a flow path, the variation in the OH distance in a direction along which ejection openings are arranged may not be able to sufficiently improve, depending on the position of the arranged base unit and the width of the base unit. For example, as shown in Japanese Patent Laid-Open No. 2007-216630, if the mold unit of the flow path and the base unit have therebetween a wide gap or if the base unit has a narrow width, then the ejection opening is close to the unevenness, thus causing the OH distance to have a remarkable variation. If the substrate is spin-coated with resin forming the orifice plate in particular, the resin layer forming the orifice plate may have a varied film thickness at the periphery of the unevenness along the spin extension direction.

### First Embodiment

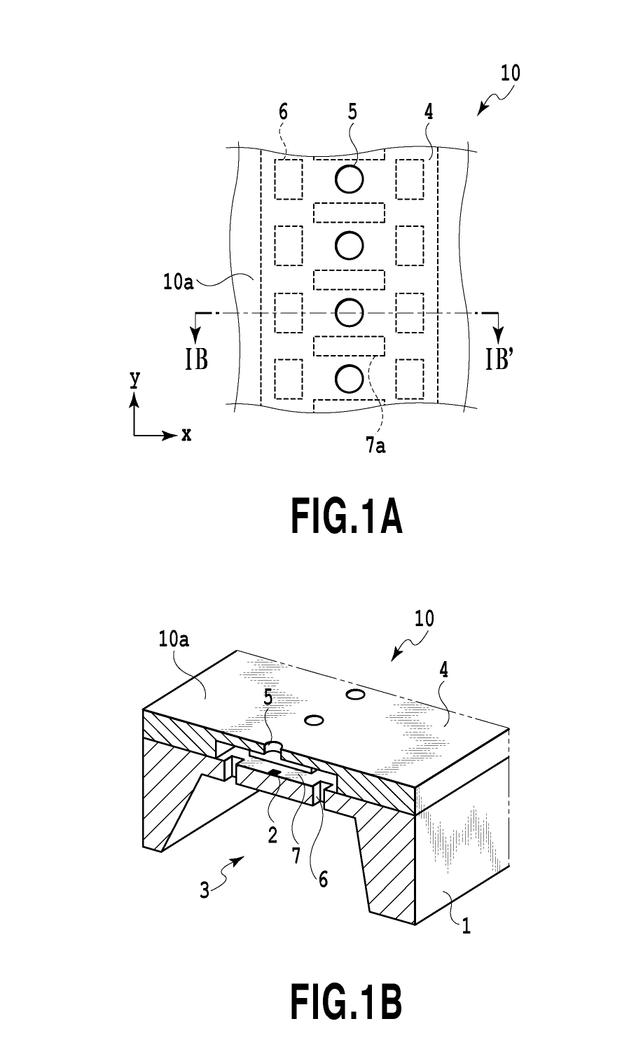

A description will be made on the method of manufacturing the liquid ejection head according to a first embodiment of the present invention with reference to the drawings. FIGS. 1A and 1B illustrate a part of the liquid ejection head manufactured by the manufacture method of this embodiment. FIG. 1A is a plan view schematically illustrating an ejection opening surface 10a of a liquid ejection head 10 including an ejection opening 5 for ejecting liquid. FIG. 1B is a perspective view illustrating the cross section taken at the line IB-IB′ of FIG. 1A. The liquid ejection head 10 has a silicon substrate 1 (hereinafter will be simply referred to as substrate) that an ejection energy generation elements 2 for generating energy to eject liquid such as ink are arranged. The substrate 1 has a common liquid chamber 3 to supply liquid. A surface of the substrate 1 (an upper surface in FIG. 1B) has thereon a flow path forming member 4.

The flow path forming member 4 has an ejection openings 5 formed at positions opposed to the ejection energy generation element 2, a plurality of flow paths 7 provided to correspond to a plurality of ejection openings, and a plurality of liquid supply openings 6 for allowing the plurality of flow paths 7 to individually communicate with the common liquid chamber 3. Liquid supplied to the common liquid chamber 3 reaches the flow path 7 through a liquid supply opening 6 and is filled in the ejection opening 5. The flow path forming member 4 in this embodiment is obtained by dividing a wall 7a forming the individual flow paths 7 providing the communication from the liquid supply opening 6 to the respective ejection openings 5 and an orifice plate including the ejection openings 5.

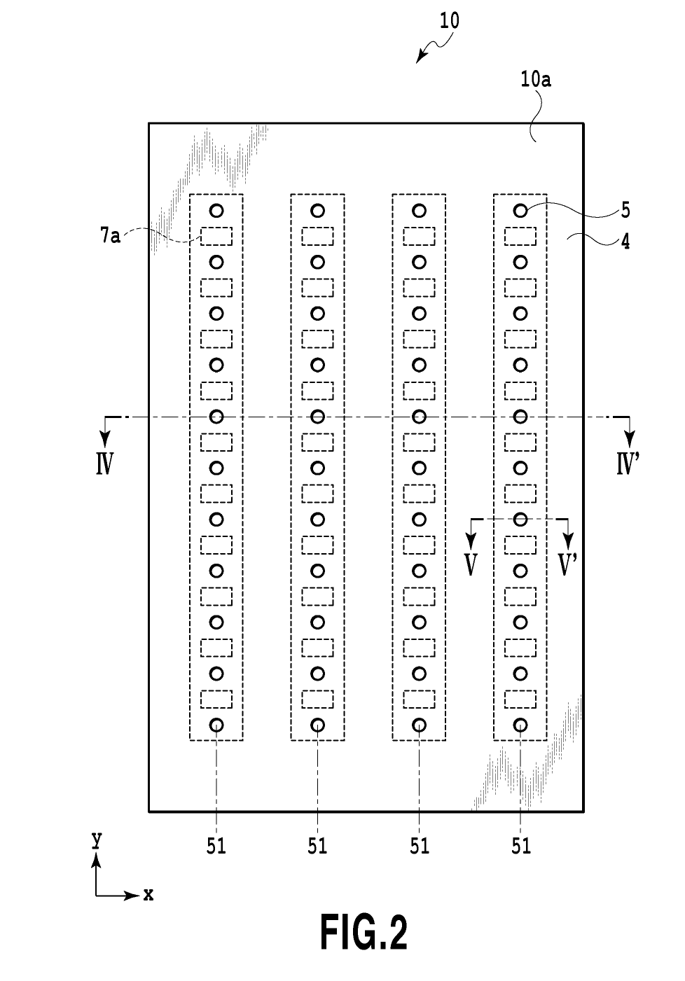

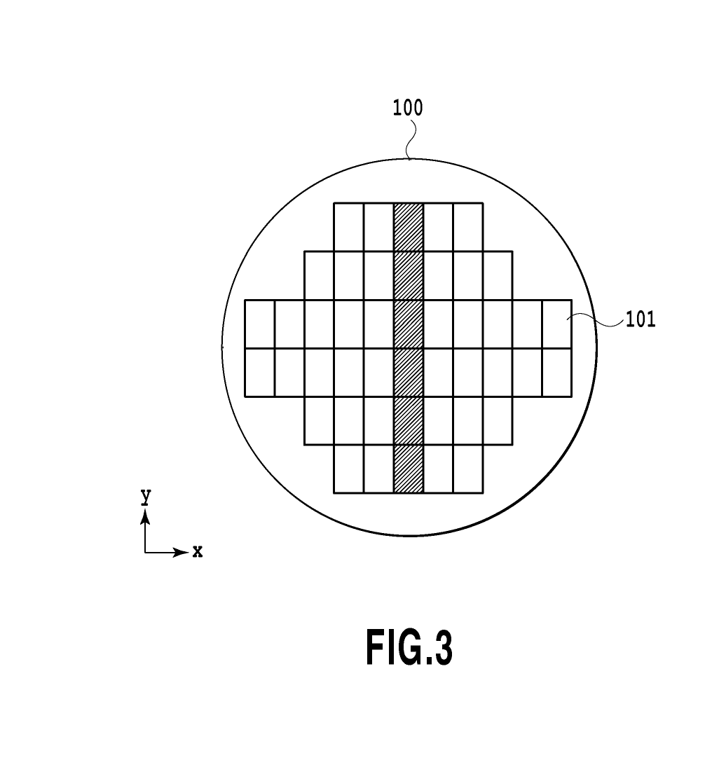

FIG. 2 is a plan view illustrating the entire configuration of the liquid ejection head formed as a chip manufactured by this embodiment. As shown in FIG. 2, the liquid ejection head 10 formed as one chip includes therein a plurality of ejection opening arrays 51 consisting of the ejection opening arrays 5 shown in FIGS. 1A and 1B that are arranged in the direction x (4 arrays are shown in the drawing). A plurality of chips 101 including these ejection opening arrays 51 are arranged within a wafer 100 as shown in FIG. 3. In FIGS. 1A and 1B and FIG. 2, the direction y represents a direction along which the ejection openings 5 are arranged in each ejection opening array 51.

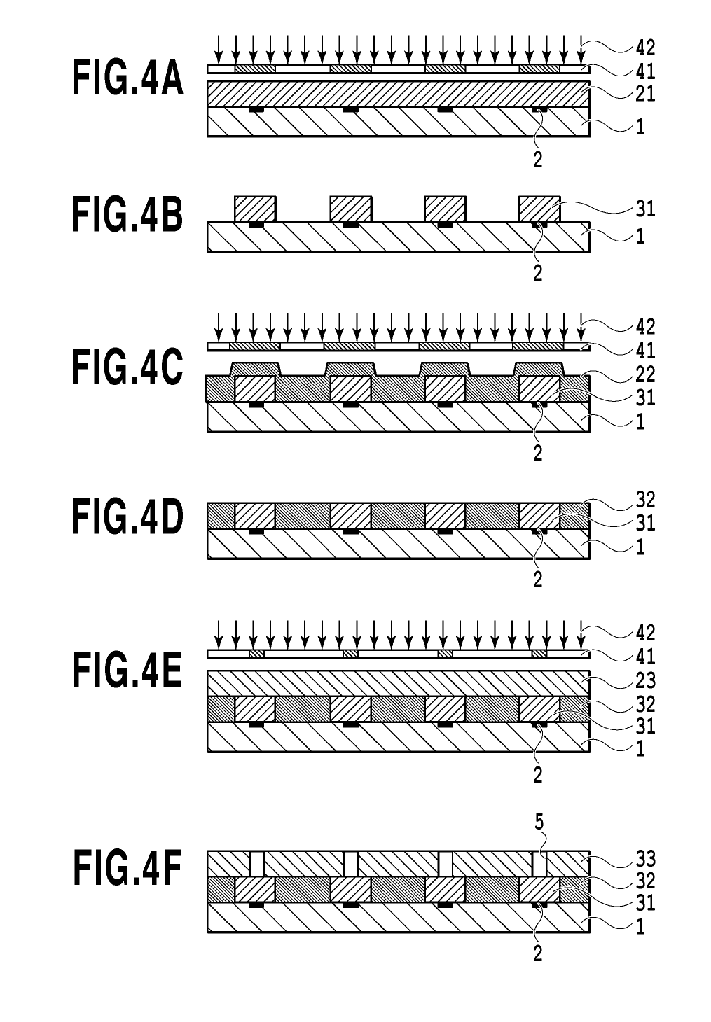

Next, a description will be made on a method of manufacturing the liquid ejection head 10 having the above configuration. FIGS. 4A to 4F are a longitudinal cross-sectional side view schematically illustrating the respective manufacture steps in the first embodiment and illustrates a status taken along the line IV-IV′ of FIG. 2. The surface of the substrate 1 has thereon a photosensitive resin layer functioning as the first layer 21. Photosensitive wavelength light 42 is irradiated via a mask 41 (FIG. 4A) to form the first pattern 31 functioning as a mold unit for forming the flow path 7 (FIG. 4B).

The photosensitive resin forming the first layer 21 may include, for example, main chain degradable positive photosensitive resin such as polymethyl isopropenyl ketone or polyvinyl ketone. The photosensitive resin also may include high polymer main chain degradable positive photosensitive resin including methacrylate ester as a main component including homopolymer such as polymethylmethacrylate or polyethyl methacrylate or a copolymer of methyl methacrylate and methacrylic acid, acrylic acid, glycidyl methacrylate, or phenyl methacrylate for example.

Next, the photosensitive resin is coated on the substrate 1 and the first pattern 31 to form a negative photosensitive resin layer 22 functioning as the second layer. Thereafter, the photosensitive wavelength light 42 is irradiated via the mask 41 (FIG. 4C). The photosensitive resin coated on the first pattern 31 is removed to thereby form the second pattern 32 functioning as a base unit (FIG. 4D). The photosensitive resin forming the second layer 22 may be chemical amplification-type negative photosensitive resin including photo-acid generating agent for example. The plurality of second patterns 32 are provided and function as a base unit. In this manner, the surface of the substrate 1 has thereon a mold unit for forming a flow path and a base unit adjacent to the mold unit.

Next, a liquid-like resin composition is coated on the second pattern 32 functioning as the base unit so as to cover the surface of the mold unit and the surface of the base unit to form the third layer (covering resin layer) 23 forming an orifice plate. Thereafter, the photosensitive wavelength light 42 is irradiated via the mask 41 (FIG. 4E) to remove a part not irradiated with the light 42 to thereby form the ejection opening 5 (FIG. 4F). The resin composition may be a photosensitive resin composition including photosensitive resin for example. The photosensitive resin forming the third layer 23 may be a chemical amplification-type negative photosensitive resin including a photo-acid generating agent for example. The resin used for the third layer 23 is composed of a constituent material similar to the constituent material of the resin used for the second layer 22 except for a solvent amount.

Next, an Si anisotropic etching is performed from the back surface side of the liquid ejection head 10 (the lower surface side in FIGS. 1A and 1B and FIGS. 4A to 4F) in order to form the common liquid chamber 3. Furthermore, a dry etching is performed in order to form an independent liquid supply opening 6 to thereby remove a mold unit 31 to subsequently perform a cure step. As a result, the liquid ejection head 10 having the configuration shown in FIG. 1B is manufactured.

As described above, in this embodiment, in order to reduce the variation in the position and width of the second pattern 31 and the OH distance (the distance between the ejection energy generation element 2 and the ejection opening surface 10a), the second pattern 32 functioning as a base unit is formed at a side of the mold unit 31 for forming the flow path 7. However, the variation in the OH distance may not be able to be sufficiently reduced or may increase depending on the position and width at which the second pattern 32 functioning as a base unit is formed. To prevent this, this embodiment is further configured so as to set the position and width at which the second pattern 32 functioning as a base unit is formed so that the variation in the OH distance can be suppressed.

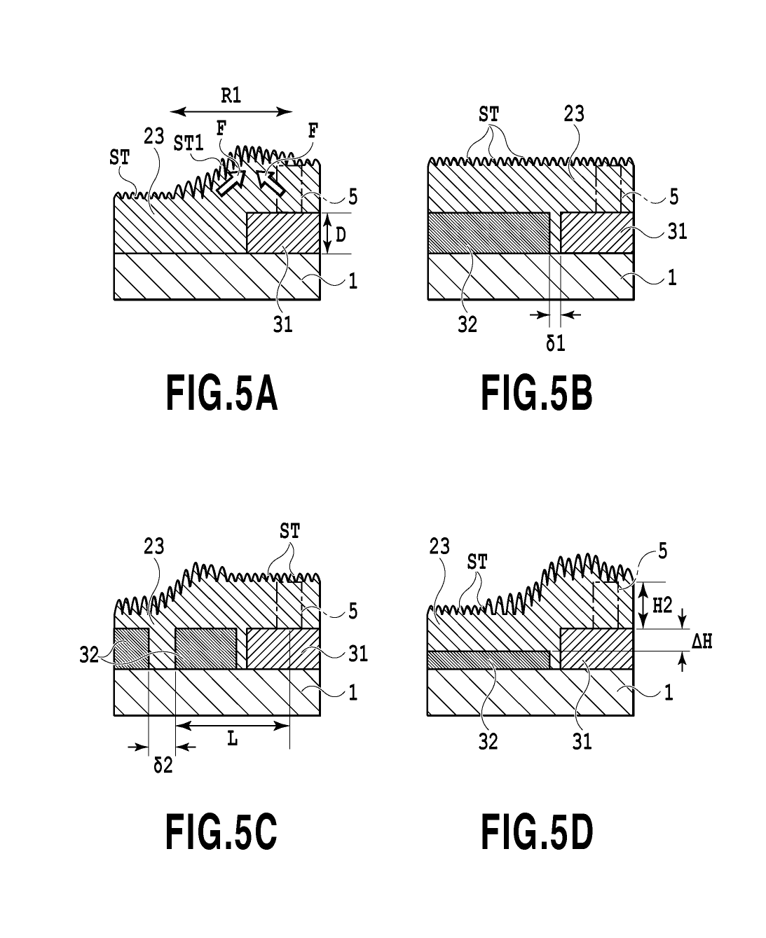

An explanation will be made on how the variation in the OH distance is caused in the liquid ejection head 10 using FIGS. 5A to 5D. FIGS. 5A to 5D illustrate a status immediately after photosensitive resin forming the third layer 23 is coated on one chip among a plurality of chips (chips shown by the diagonal lines of FIG. 3) arranged in a diameter direction of the wafer 100 shown in FIG. 3. FIGS. 5A to 5D corresponds to the cross section taken along the line V-V′ of FIG. 2.

When the liquid-like resin composition is coated by spin coating, as shown in FIGS. 5A to 5D, striation is caused on the surface of the coated resin composition (the upper surface in the drawing) depending on the drying distribution during spinning. This phenomenon called striation is a phenomenon in which the film thickness varies in a streaky manner along the spinning extension direction (a direction orthogonal to the papers of FIGS. 5A to 5D). In the drawings, the term “St” represents the irregularities formed due to this striation. When a substrate including unevenness in a direction parallel to the spin extension direction is spin-coated, a phenomenon is caused in which the irregularity St due to the striation is amplified. This status is shown in FIG. 5A. The substrate 1 shown in FIG. 5A has thereon the mold unit 31 for forming the flow path 7 only and has thereon no base unit 32 and a unevenness D is formed between the surface of the substrate 1 and the mold unit 31.

When the liquid-like resin composition is coated on this substrate 1, a covering resin layer for covering the edge of the unevenness D has a reduced thickness at the beginning of the coating. Thus, the solid content concentration of the resin composition covering the edge is locally increased due to drying to increase the surface tension, which causes the resin in the resin composition to macroscopically flow in a direction along which the liquid is drawn (a direction shown by the arrow F of FIG. 5A). As a result, in the range R1 among the coated resin composition within which the edge of the unevenness D is coated, the irregularity St formed by the striation is further amplified to result in the one as shown in St1, causing a significant variation in the film thickness of the covering resin layer. When the unevenness D exists at a position close to the ejection opening 5, the influence by the film thickness variation of the resin as described above undesirably reaches the ejection opening 5, resulting in a variation in the OH distance.

On the other hand, in this embodiment, with regard to the mold unit (the first pattern) 31 forming the unevenness D on the substrate 1, the formation position and thickness of the second pattern 32 forming abase unit are set as shown below to thereby suppress the variation in the film thickness of the resin coated on the substrate 1.

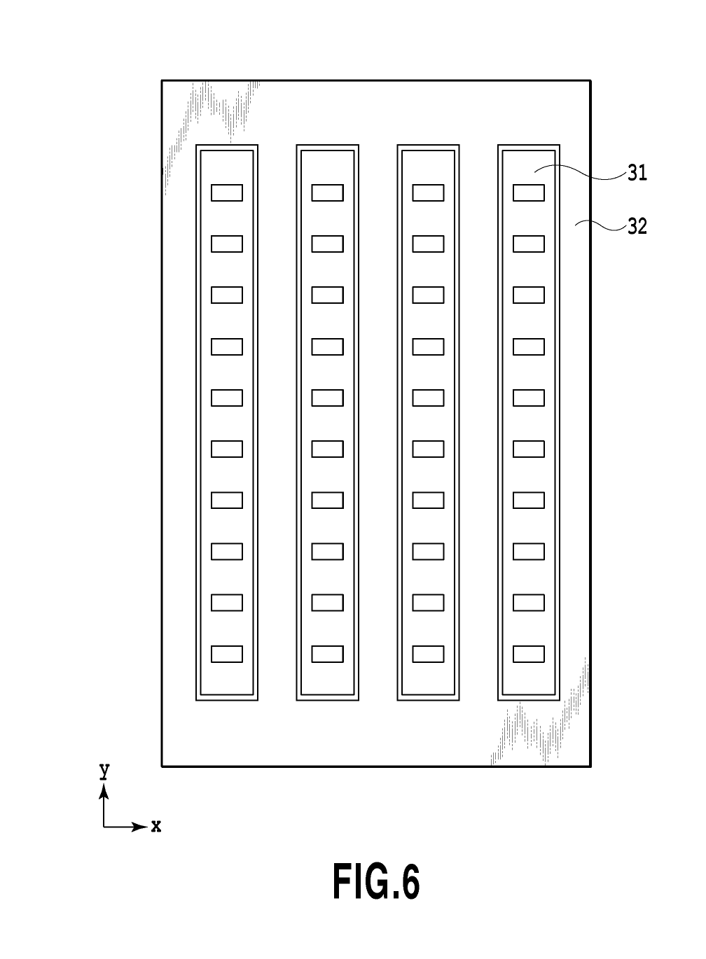

First, in a direction parallel to the surface of the substrate 1, the distance δ1 between the first pattern 31 and the second pattern 32 (FIG. 5B) (i.e., the interval δ1 between one end of the base unit and a mold unit adjacent thereto) is set to a value within 30 μm. The term “one end of the base unit” means an end among ends of the base unit that is closest to the mold unit. In this case, the second pattern 32 is configured, as shown in FIG. 6, as a pattern having a wide width (of 300 μm or more) extending to the neighborhood of the first pattern 31 forming a mold unit for forming the flow path 7 of the adjacent ejection opening array 51. When the first pattern 31 formed on the substrate 1 is discontinued as shown in FIG. 5C, the interval δ2 of the discontinued pattern (i.e., the interval δ2 of the plurality of base units) is set within 30 μm. However, when the interval δ2 of the discontinued pattern must be 30 μm or more, the influence by the variation in the film thickness caused by the unevenness is suppressed from reaching the ejection opening 5 by setting the distance L (FIG. 5C) from the center of the ejection opening 5 to the other end of the base unit (unevenness) to 300 μm or more. The term “the other end of the base unit” means an end at an opposite side of the one end. FIG. 5B shows a case where the surface of the second pattern 32 (the upper surface in the drawing) has a height that is formed to provide a thickness having the same height as that of the surface of the first pattern 31. The term “height” means a height in a direction vertical to the surface of the substrate 1. In this case, ΔH=0 μm is established.

As described above, the first pattern 31 forming a base unit and the second pattern 32 functioning as a mold unit for forming the flow path 7 are formed in a continuous plane by causing the second pattern 32 to be adjacent to the first pattern 31. Specifically, even when liquid-like resin forming the third layer 23 is coated, the resin only enters a small gap of both patterns. This suppresses the edge of the first pattern 31 from having a reduced thickness, thus causing a very little influence on the height (film thickness) of the covering resin layer coated on both patterns. Thus, even when the striation is caused by spin coating, the irregularity St due to the striation is suppressed from being amplified at the edge of the first pattern 31, thus allowing the third layer 23 functioning as a covering resin layer to have a substantially-uniform film thickness as shown in FIG. 5B. This consequently can reduce the variation in the OH distance.

The first pattern 31 functioning as a mold unit for forming the flow path 7 and the second pattern 32 functioning as a base unit preferably have the same height as shown in FIG. 5B. However, there also may be a case as shown in FIG. 5D in which the surface of the first pattern 31 and the surface of the second pattern 32 must have therebetween an unevenness (a difference in the height in the surface direction of the substrate 1). In this case, the relation between the height ΔH of the unevenness caused between the first pattern 31 and the second pattern 32 and the orifice plate thickness H2 is set to H2/ΔH≧3 as described above. This consequently allows, even when the unevenness having the height ΔH is formed, a covering resin layer having a thickness three or more times higher than that of the height ΔH is formed. Thus, the height ΔH of the unevenness can be prevented from having a significant influence on the film thickness, thus suppressing the variation in the OH distance.

The above description will be summarized below. In order to form a base unit so that δ2≦30 μm is established, the base unit and the covering resin layer are formed so that the relations of δ1≦30 μm and ΔH=0 μm or H2/ΔH≧3 are satisfied. In order to form a base unit so that δ2>30 μm is established on the other hand, the base unit and the covering resin layer are formed so that the relations of δ1≦30 μm, L≧300 μm and ΔH=0 μm or H2/ΔH≧3 are satisfied. According to this embodiment, even when liquid-like resin for forming the flow path forming member 4 is coated on the substrate 1 having thereon unevenness, the flow path forming member 4 can be suppressed from having a variation in the film thickness, thus realizing the manufacture of a liquid ejection head having superior ejection performance and durability. Furthermore, resin having a uniform film thickness can be used to protect a wiring and an electric circuit formed on the substrate 1, thus providing the liquid ejection head 10 having superior liquid durability and reliability.

### Second Embodiment

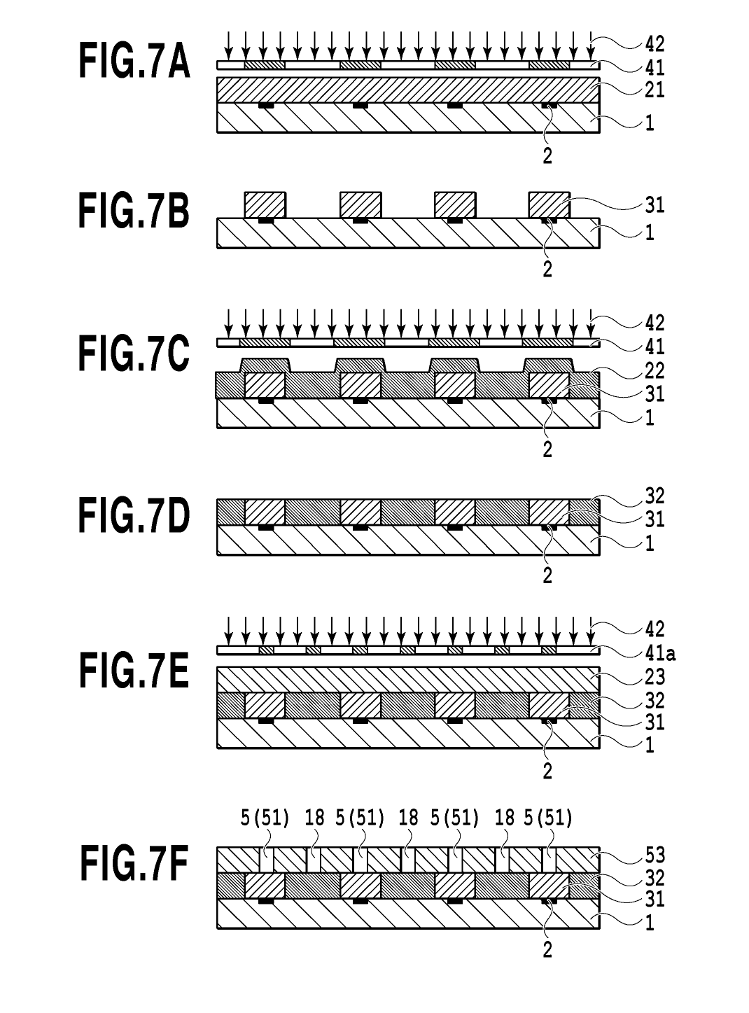

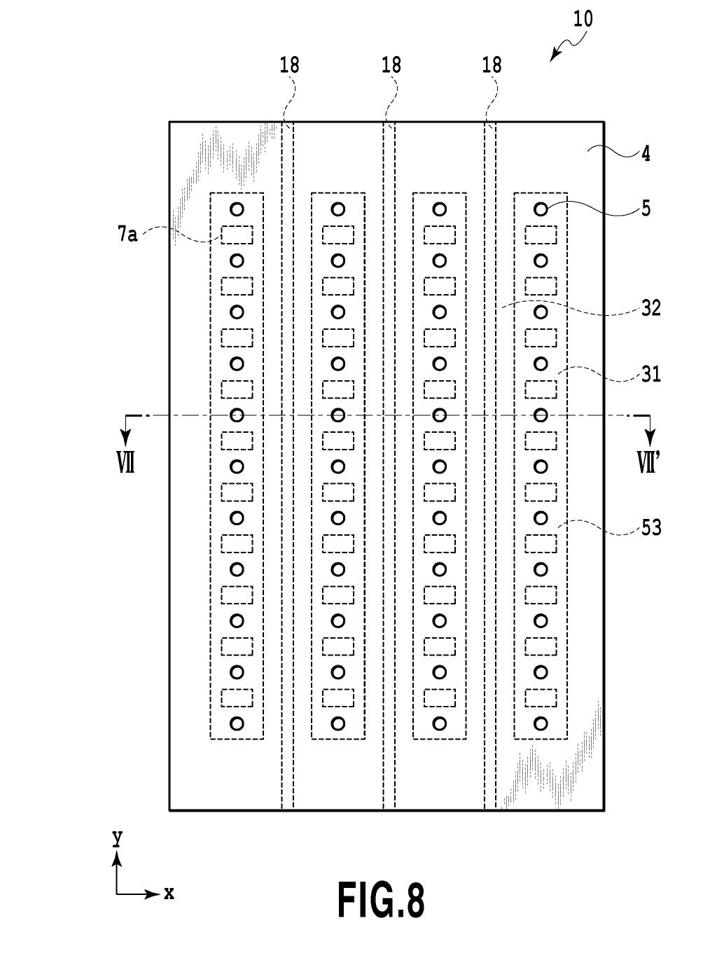

Next, an explanation will be made on the second embodiment of the present invention with reference to FIGS. 7A to 7F and FIG. 8. FIGS. 7A to 7F are a schematic cross-sectional view illustrating the status of the liquid ejection head shown in FIG. 8 taken along the line VII-VII′. FIG. 8 is a plan view illustrating the liquid ejection head 10 manufactured by this second embodiment. In FIGS. 7A to 7F, parts that are the same as or that correspond to those shown in FIGS. 4A to 4F are denoted with the same reference numerals.

This second embodiment is characterized in having a portion for preventing the deformation of the substrate 1 due to the cure shrinkage during the formation of the third pattern 53 functioning as an orifice plate (deformation prevention portion). Specifically, in a step of forming the second pattern 32 for forming the flow path forming member 4 to subsequently form the third pattern 53, the ejection opening 5 is formed simultaneously with the formation of slits penetrating the third pattern (penetration portion) 18 functioning as a deformation prevention portion among a plurality of the ejection opening arrays 51. Steps of forming the first pattern 31 functioning as a mold unit for forming the flow path 7 on the substrate 1 and the second pattern 32 functioning as a base (FIGS. 7A to 7D) are similar to those in the first embodiment (FIGS. 4A to 4D). Thus, this second embodiment is similar to the first embodiment in that the film thickness of the third layer 23 for forming the third pattern 53 is formed uniformly.

A step of forming the ejection opening 5 and a slit 18 in the third layer 23 uses the mask 41a. The mask 41a includes therein a pattern for forming the ejection opening 5 and a pattern for forming the slit 18. The photosensitive wavelength light 42 is irradiated via this mask 41a to the third layer 23 (FIG. 7E). Resin irradiated with the light is removed to thereby form a plurality of the ejection openings 5 and a plurality of the slits 18 between a plurality of the ejection openings 5 and a plurality of the ejection opening arrays 51 consisting of these ejection openings 5 (see FIG. 7F and FIG. 8). This consequently forms the third pattern 53 in this embodiment. Thereafter, the common liquid chamber 3 for supplying ink to the back surface of the substrate 1 is formed to thereby manufacture the liquid ejection head 10 having the configurations shown in FIGS. 1A and 1B and FIG. 8.

As described above, according to this second embodiment, the slit 18 is formed in the third pattern 53 functioning as an orifice plate. Thus, the cure shrinkage force of the resin forming the third pattern 53 is dispersed by the slit 18, thus reducing the force acting on the substrate 1. Thus, the deformation of the substrate 1 due to the cure shrinkage of the resin can be suppressed, thus suppressing the variation in the OH distance more securely. Furthermore, this second embodiment is similar to the first embodiment in that resin having a uniform film thickness can be used to protect the wiring and electric circuit of the substrate 1, thus providing the liquid ejection head 10 having superior liquid durability and reliability.

### Third Embodiment

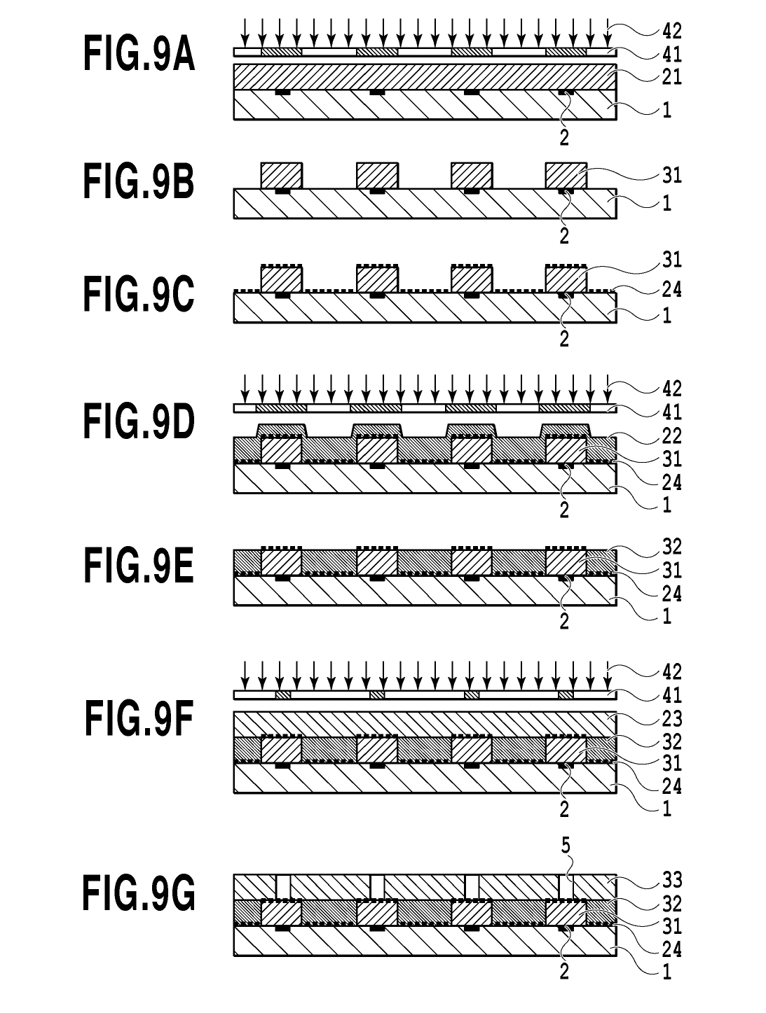

Next, a description will be made on the third embodiment of the present invention with reference to FIGS. 9A to 9G. FIGS. 9A to 9G are schematic cross-sectional view illustrating the status taken along V-V′ of FIG. 2. In this third embodiment, the adhesion between the second pattern 32 functioning as a base and the substrate 1 is secured by applying adhesion auxiliary agent to form an adhesion layer 24. Specifically, as in the first embodiment, a photosensitive resin layer 21 functioning as the first layer 21 is provided on the substrate 1 and the photosensitive wavelength light 42 is irradiated via the mask 41 (FIG. 9A), thereby forming the first pattern 31 functioning as a mold unit for forming the flow path 7 (FIG. 9B). Photosensitive resin forming the first layer 21 can be the same resin as that of the first embodiment.

As shown in FIG. 9B, after the formation of the first pattern 31 functioning as a mold unit for forming the flow path 7 on the substrate 1, then the adhesion auxiliary agent is coated on the surface of the substrate 1 (the upper surface in the drawing) and the surface of the first pattern 31 to form the adhesion layer 24 (FIG. 9C). This adhesion layer 24 has a purpose of improving the adhesion between the second pattern 32 and the substrate 1 formed by the steps shown in FIGS. 9D and 9E. The adhesion auxiliary agent may be ethanol solution including silane agent.

Next, the negative photosensitive resin layer is coated to thereby form the second layer 22 for forming a base unit and the photosensitive wavelength light 42 is irradiated (FIG. 9D), thereby forming the second pattern 32 functioning as a base unit (FIG. 9E). The same resin as that in the first embodiment also can be used for the photosensitive resin forming the second layer 22. The second pattern 32 functioning as a base unit is formed so as to satisfy the conditions of the layout and film thickness shown in the first embodiment.

Next, the third layer 23 forming an orifice plate is formed and the photosensitive wavelength light 42 is irradiated via the mask 41 (FIG. 9F), thereby forming the ejection opening 5 by development (FIG. 9G). When the adhesion auxiliary agent is coated prior to the formation of the third layer 23 and the second pattern 32 functioning as a base unit is insufficiently cured, the second pattern 32 may be slightly dissolved due to the solvent included in the adhesion auxiliary agent, which may damage the uniformity of the film thickness. To prevent this, according to this embodiment, no adhesion auxiliary agent is coated immediately before the formation of the third layer 23. In this manner, the third pattern 33 functioning as an orifice plate is formed.

Next, in order to form the common liquid chamber 3 for supplying ink to the back surface, an Si anisotropic etching and a dry etching for forming the liquid supply opening 6 are performed to remove the mold unit 31 for forming the flow path 7 after which a cure step is performed. As a result, the liquid ejection head 10 having the configurations shown in FIGS. 1A and 1B can be manufactured.

As described above, according to this third embodiment, the adhesion layer 24 is formed on the substrate 1. Thus, the adhesion between the substrate 1 and the second pattern 32 can be improved, thus manufacturing a liquid ejection head having higher durability and reliability. The third embodiment is similar to the first embodiment in that resin having a uniform film thickness can be formed, thus suppressing the variation in the OH distance.

### Other Embodiments

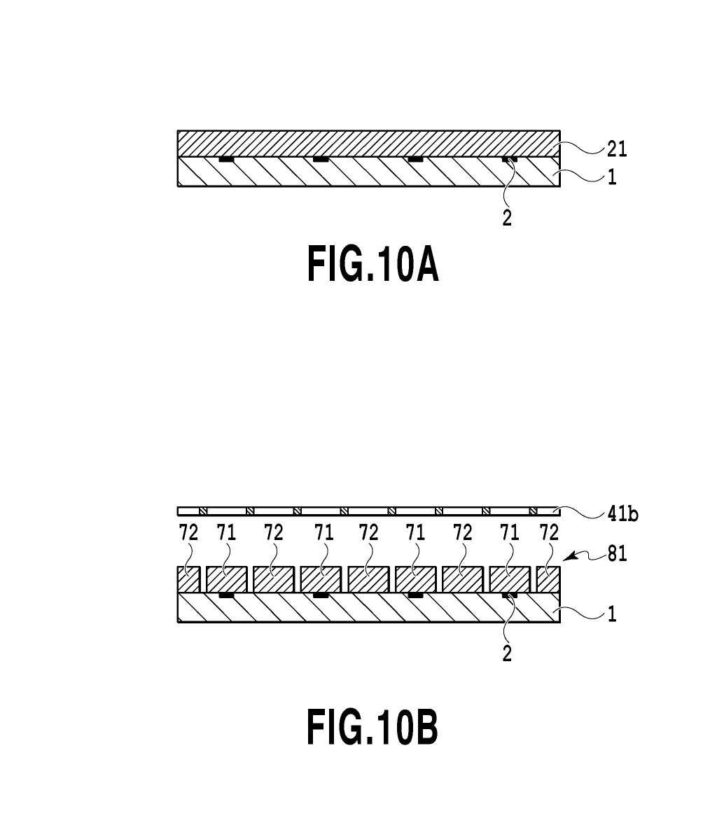

In the above respective embodiments, a mold unit is formed by forming the first pattern 31 after which the second pattern 32 is formed. However, a mold unit and a base unit also may be simultaneously formed by the first pattern 31. For example, as shown in FIG. 10A, the first resin layer 21 is formed by photosensitive resin on the surface of the substrate 1. After the exposure via the mask 41b is performed as shown in FIG. 10B, unnecessary resin is removed by development. By forming the first pattern 31 in this manner, the mold unit 71 and the base unit 72 for forming the flow path 7 can be formed simultaneously.

If the substrate 1 has thereon regions having different heights due to electric wiring for example, the film thickness of the base unit can be changed depending on each region, thereby suppressing the variation in the film thickness in the covering resin layer for forming an orifice plate. When divided base units are formed among neighboring mold units, the divided base units also can be formed to have different thicknesses, respectively.

The above respective embodiments have been described by way of a case where resin is coated by spin coating. However, the variation in the film thickness may be caused due to the unevenness formed on a substrate also in the case where methods other than the spin coating are used to coat resin. In such a case, the manufacture method according to the present invention can be performed to thereby suppress the variation in the film thickness of the covering resin layer coated so as to cover the unevenness.

The resin material used for the formation of the first, second, and third layers of the above embodiments are the one generally used in a liquid ejection head. Thus, this embodiment can be useful for liquid ejection heads using other general resin materials. Specifically, any liquid ejection head using general resin material may be used to suppress the variation in the OH distance by setting the above-described δ1, δ2, L, and H2/ΔH.

### EXAMPLES

A description will be more specifically made on a method of manufacturing the liquid ejection head according to the present invention based on Examples and Comparison Examples shown below.

### Example 1

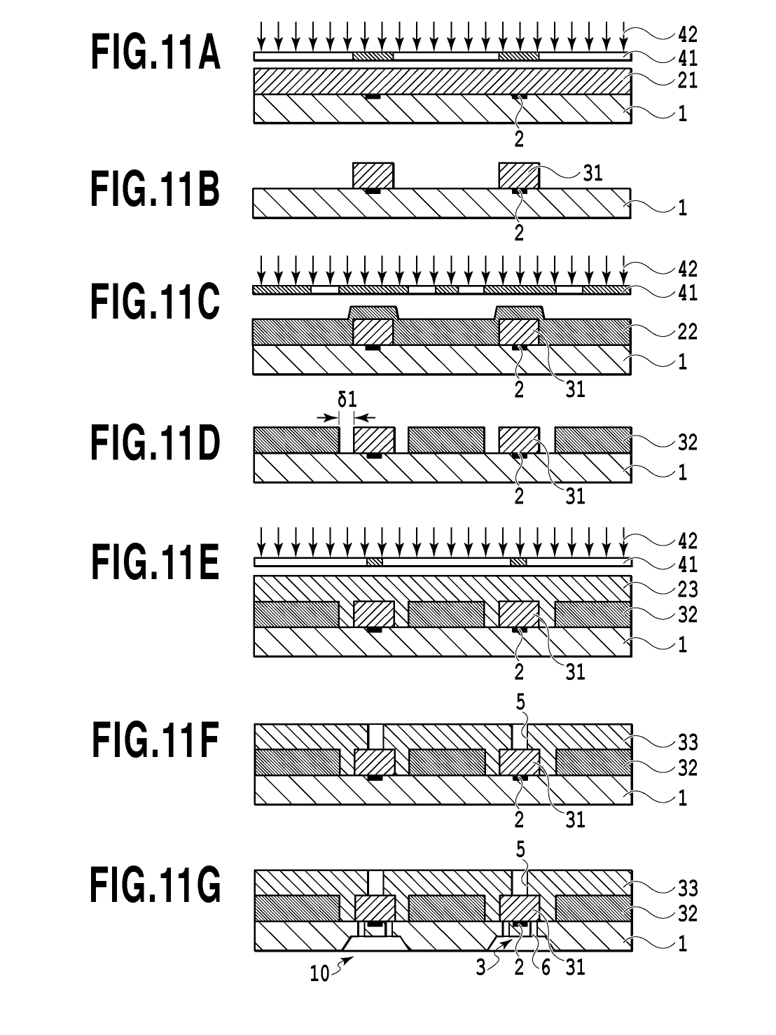

FIGS. 11A to 11G illustrate the manufacture method of the liquid ejection head shown in Example 1. FIGS. 11A to 11G are a schematic cross-sectional view illustrating the status taken along IV-IV′ of FIG. 2.

First, positive photosensitive resin was coated on the surface of the substrate 1 having thereon the ejection energy generation element 2 and a semiconductor device for performing the driving and control thereof, thereby forming the first layer 21 (FIG. 11A). The positive photosensitive resin was ODUR-1010 (made by TOKYO OHKAKOGYO CO., LTD.) and this resin was coated to reach 6 μm by spin coating to subsequently dry the region, thereby forming the first layer 21.

Next, ultraviolet light having a photosensitive wavelength region was irradiated to the first layer 21 (FIG. 11A). This ultraviolet light was pattern-irradiated using a mask aligner UX-3000SC ((product name); made by Ushio co., LTD.) and Deep-UV light was irradiated at a rate of 20 J/cm². Thereafter, CDS-8000 was used to perform a methyl isobutyl ketone development and rinsing with isopropyl alcohol was performed, thereby forming the first pattern 31 functioning as a mold unit for forming the flow path 7 (FIG. 11B).

Next, negative photosensitive resin was coated on the substrate 1 having thereon the first pattern 31 to have a thickness of 6 μm to subsequently dry the resin, thereby forming the second layer 22. The negative photosensitive resin used was the one consisting of EHPE-3150 (made by Daicel Corporation: 100 parts by mass, A-187 (made by Nippon Unicar Company Limited: 5 parts, SP-170 (made by ADEKA CORPORATION): 2 parts by mass, and xylene: 150 parts by mass. Thereafter, a stepper FPA-3000i5+ ((product name); made by Canon Inc.) was used to expose the second layer 22 to ultraviolet light (FIG. 11C). Next, post baking and the development with mixed liquid of methyl isobutyl ketone/xylene=2/3 were performed, forming the second pattern 32 functioning as a base unit (FIG. 11D). In this Example 1, the height of the surface of the first pattern 31 functioning as a mold unit for forming the flow path 7 (the distance in a vertical direction from the surface of the substrate) is set to the same height of the surface of the second pattern 32 functioning as a base unit. Furthermore, in a direction parallel to the surface of the substrate, the distance (δ1) between the mold unit 31 and one end of the base unit 32 was set to 30 μm. Neighboring mold units 31 were allowed to have thereamong a continuous base unit 32. The distance L from the other end of this continuous base unit 32 to the center of the ejection opening was set to 300 μm. The base units are continuous and no interval is provided among the base units, thus establishing δ2=0 μm.

Next, negative photosensitive resin was coated on the surface of the substrate 1 as a liquid-like resin composition by spin coating on the mold unit 31 to have a thickness of 6 μm so as to cover the first and second patterns 31 and 32. Thereafter, the resin was dried to form the third layer 23 functioning as a orifice plate. The negative photosensitive resin used was the one consisting of EHPE-3150 (made by Daicel Corporation): 100 parts by mass, A-187 (made by Nippon Unicar Company Limited): 5 parts by mass, SP-170 (made by ADEKA CORPORATION): 2 parts by mass, and xylene: 150 parts by mass. Thereafter, a stepper FPA-3000i5+ ((product name); made by Canon Inc.) was used to expose the third layer to ultraviolet light (FIG. 11E). Thereafter, the post baking and the development with mixed liquid of methyl isobutyl ketone/xylene=2/3 were performed, thereby removing an unexposed portion. As a result, the third pattern 33 functioning as an orifice plate including the ejection opening 5 was formed (FIG. 11F). Since the surfaces of the first and second patterns 31 and 32 have the same height, these surfaces had an unevenness (ΔH)=0 μm.

Thereafter, in order to protect the orifice plate, the substrate surface and the periphery thereof were coated with not-shown rubber resin. A chemical dry etching was performed with polyether amide as a mask and the Si anisotropic etching was performed with 22 wt % tetramethylammonium hydroxide (TMAH) as etchant. Furthermore, a dry etching was performed in order to form two independent liquid supply openings 6 for each ejection opening. Next, ultraviolet light having a photosensitive wavelength region was irradiated to remove the mold unit 31 with methyl lactate to subsequently perform a cure step at 200 degrees C. for 1 hour. By the steps as described above, the liquid ejection head 10 was manufactured for which the thickness (H2) in a direction vertical to the surface of the substrate of the third layer 23 functioning as a covering resin layer is 6 μm and the OH distance is 12 μm (FIG. 11G).

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, providing a favorable result (A).

### Example 2

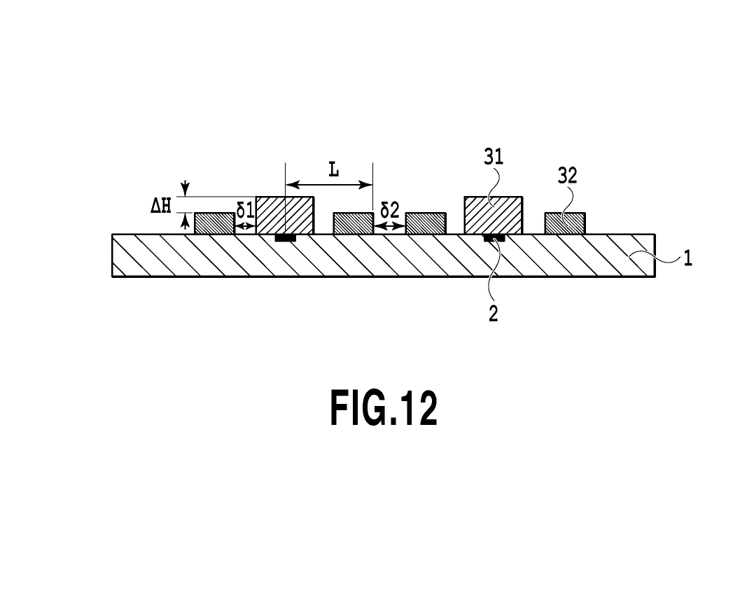

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 were set to the same height (these surfaces had an unevenness (ΔH)=0 μm), and the distance (δ1) between the mold unit 31 and one end of the base unit 32 was set to 30 μm. However, two divided base units 32 were formed between neighboring mold units 31 as shown in FIG. 12. The distance between these base units 32 (distance between base units) (δ2) was set to 50 μm. The distance (L) between the center of the ejection opening 5 and the other end of the base unit 32 was set to 500 μm. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, providing a favorable result (A).

### Example 3

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 were set to the same height (these surfaces had an unevenness (ΔH)=0 μm), and the distance (δ1) between the mold unit 31 and one end of the base unit 32 was set to 30 μm. Example 3 is similar to Example 2 in that two divided base units 32 were formed between neighboring mold units 31 as shown in FIG. 12. The distance between these base units 32 (distance between base units) (δ2) was set to 50 μm. The distance (L) between the center of the ejection opening 5 and the other end of the base unit 32 was set to 30 μm. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, providing a favorable result (A).

### Example 4

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 were set to the same height (these surfaces had an unevenness (ΔH)=0 μm), and the distance (δ1) between the mold unit 31 and one end of the base unit 32 was set to 30 μm. Example 4 is similar to Example 2 in that two divided base units 32 were formed between neighboring mold units 31 as shown in FIGS. 11A to 11G. The distance between these base units 32 (distance between base units) (δ2) was set to 30 μm. The distance (L) between the center of the ejection opening 5 and the other end of the base unit 32 was set to 150 μm. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, providing a favorable result (A).

### Example 5

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 differed by an unevenness of 2 μm (ΔH). Thus, a ratio (H2/ΔH) between was set at 3. The distance (δ1) between the mold unit 31 and one end of the base unit 32 was set to 30 μm. Divided base units 32 were formed between neighboring mold units 31 as in Example. Specifically, δ2=0 μm was established. The distance L between the other end of these continuous base units 32 and the center of the ejection opening was set to 300 μm. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, providing a favorable result (A).

### Example 6

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 18 μm, the height of the surface of the mold unit 31 and the height of the surface of the base unit 32 differed by an unevenness of 6 μm (ΔH). Thus, a ratio between the thickness (H2) of the third layer 23 and the unevenness (ΔH) was set at 3. The distance (δ1) between the mold unit 31 and one end of the base unit 32 was set to 30 μm. Continuous base units 32 were formed between neighboring mold units 31 as in Example 1. Specifically, δ2=0 μm was established. The distance L between the other end of these continuous base units 32 and the center of the ejection opening was set to 300 μm. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, providing a favorable result (A).

### Comparison Example 1

In the similar manner as in Example 1, with regard to the substrate 1 including the ejection energy generation element 2, the first pattern 31 functioning as a mold unit for forming the flow path 7 was formed. Then, the third layer 23 functioning as an orifice plate was formed without forming the second pattern 32 functioning as a base unit. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

The liquid ejection head manufactured in the manner as described above does not have the second pattern functioning as a base unit. Thus, the third layer 23 functioning as a covering resin layer is formed with the existence of the unevenness (ΔH) of 6 μm, thus resulting in the ratio between the thickness H2 of the third layer 23 and the unevenness ΔH being set at 1 (<3). As a result, the evaluation of those liquid ejection heads corresponding to chips denoted with the diagonal lines in the wafer 100 shown in FIG. 3 with regard to the variation in the OH distance in the ejection opening array resulted in a significant variation (C).

### Comparison Example 2

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 were set to the same height (these surfaces had an unevenness (ΔH)=0 μm), and the distance (δ1) between the mold unit 31 of the flow path and one end of the base unit 32 was set to 40 μm. Between neighboring mold units 31, no interval between base units was provided (δ2=0 μm, thereby forming continuous base units 32 as in Example 1. The distance L from the other end of this continuous base unit 32 to the center of the ejection opening was set to 300 μm. Except for these points, the same method as in Example 1 was subsequently used to perform the formation coating of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, resulting in a slight variation in the OH distance (B).

### Comparison Example 3

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 were set to the same height (these surfaces had an unevenness (ΔH)=0 μm), and the distance (δ1) between the mold unit 31 and one end of the base unit 32 was set to 50 μm. The Comparison Example 3 is similar to Example 1 in that continuous base units 32 were formed between neighboring mold units 31 (δ2=0 μm). The distance L from the other end of this continuous base unit 32 to the center of the ejection opening was set to 300 μm. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, resulting in a slight variation in the OH distance (C).

### Comparison Example 4

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 were set to the same height (these surfaces had an unevenness (ΔH)=0 μm), and the distance (δ1) between the mold unit 31 and one end of the base unit 32 was set to 30 μm. However, two divided base units 32 were formed between neighboring mold units 31 as shown in FIG. 12. The distance between these base units 32 (distance between base units) (δ2) was set to 50 μm. The distance (L) between the center of the ejection opening 5 and the other end of the base unit 32 was set to 250 μm. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, resulting in a significant variation in the OH distance (C).

### Comparison Example 5

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 were set to the same height (these surfaces had an unevenness (ΔH)=0 μm), and the distance (δ1) between the mold unit 31 and one end of the base unit 32 was set to 30 μm. However, two divided base units 32 were formed between neighboring mold units 31 as shown in FIG. 12. The distance between these base units 32 (distance between base units) (δ2) was set to 40 μm. The distance (L) between the center of the ejection opening 5 and the other end of the base unit 32 was set to 150 μm. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, resulting in a slight variation in the OH distance (B).

### Comparison Example 6

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 were set to the same height (these surfaces had an unevenness (ΔH)=0 μm), and the distance (δ1) between the mold unit 31 and one end of the base unit 32 was set to 30 μm. However, two divided base units 32 were formed between neighboring mold units 31 as shown in FIG. 12. The distance between these base units 32 (distance between base units) (δ2) was set to 50 μm. The distance (L) between the center of the ejection opening 5 and the other end of the base unit 32 was set to 150 μm. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, resulting in a significant variation in the OH distance (C).

### Comparison Example 7

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 differed by the unevenness (ΔH) of 3 μm, whereby the a ratio (H2/ΔH) was set at 2 (<3). The distance (δ1) between the mold unit 31 and one end of the base unit 32 was set to 30 μm. A continuous base unit 32 was formed between neighboring mold units 31 as in Example 1. The distance L from the other end of this continuous base unit 32 to the center of the ejection opening was set to 300 μm. Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, resulting in a slight difference in the OH distance (B).

### Comparison Example 8

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 6 μm, the height of the surface of the mold unit 31 and the height of the surface of the base unit 32 differed by the unevenness (ΔH) of 4 μm, whereby a ratio (H2/ΔH) was set at 1.5(<3). The distance (δ1) between the mold unit 31 and one end of the base unit 32 was set to 30 μm. A continuous base unit 32 was formed between neighboring mold units 31 as in Example 1. The distance L from the other end of this continuous base unit 32 to the center of the ejection opening was set to 300 μm.

Except for these points, the same method as in Example 1 was subsequently used to perform the formation of the ejection opening 5, coating, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, resulting in a significant variation in the OH distance (C).

### Comparison Example 9

In the similar manner as in Example 1, with regard to the substrate 1 including the ejection energy generation element 2, the first pattern 31 functioning as a mold unit for forming the flow path 7 was formed and then the second pattern 32 functioning as a base unit was formed. Furthermore, the third layer 23 functioning as an orifice plate was formed. During this, the thickness (H2) of the third layer 23 was set to 18 μm, the height of the surface of the mold unit 31 and the height of the surface of the base unit 32 differed by the unevenness (ΔH) of 12 μm, whereby a ratio (H2/ΔH) was set at 1.5(<3). The distance (δ1) between the mold unit 31 and one end of the base unit 32 was set to 30 μm. A continuous base unit 32 was formed between neighboring mold units 31 as in Example 1. The distance L from the other end of this continuous base unit 32 to the center of the ejection opening was set to 300 μm.

Except for these points, the same method as in Example 1 was subsequently used to perform the formation and coating of the ejection opening 5, the formation of the common liquid chamber 3, and the processing step of the mold unit 31 for example, thereby manufacturing the liquid ejection head 10.

Among the liquid ejection heads manufactured in the manner as described above, those liquid ejection heads corresponding to chips denoted with the diagonal lines in the wafer 100 shown in FIG. 3 were evaluated with regard to the variation in the OH distance in the ejection opening array, resulting in a significant variation in the OH distance (C).

Table 1 shows the result of the evaluation of Examples 1 to 6 and Comparison Examples 1 to 9 as described above.

TABLE 1

| | | Uneven- | | | | | Variation |
|---|---|---|---|---|---|---|---|
| | | ness | | | | | in OH |
| | H2 | ΔH | H2/ | δ₁ | L | δ₂ | distance |
| | [μm] | (μm) | ΔH | (μm) | (μm) | (μm) | in array |
| Example 1 | 6 | 0 | — | 30 | 300 | 0 | A |
| Example 2 | 6 | 0 | — | 30 | 500 | 50 | A |
| Example 3 | 6 | 0 | — | 30 | 300 | 50 | A |
| Example 4 | 6 | 0 | — | 30 | 150 | 30 | A |
| Example 5 | 6 | 2 | 3 | 30 | 300 | 0 | A |
| Example 6 | 18 | 6 | 3 | 30 | 300 | 0 | A |
| Comparison | 6 | 6 | 1 | — | — | | C |
| Example 1 | | | | | | | |
| Comparison | 6 | 0 | — | 40 | 300 | 0 | B |
| Example 2 | | | | | | | |
| Comparison | 6 | 0 | — | 50 | 300 | 0 | C |
| Example 3 | | | | | | | |
| Comparison | 6 | 0 | — | 30 | 250 | 50 | C |
| Example 4 | | | | | | | |
| Comparison | 6 | 0 | — | 30 | 150 | 40 | B |
| Example 5 | | | | | | | |
| Comparison | 6 | 0 | — | 30 | 150 | 50 | C |
| Example 6 | | | | | | | |
| Comparison | 6 | 3 | 2 | 30 | 300 | 0 | B |
| Example 7 | | | | | | | |
| Comparison | 6 | 4 | 1.5 | 30 | 300 | 0 | C |
| Example 8 | | | | | | | |
| Comparison | 18 | 12 | 1.5 | 30 | 300 | 0 | C |
| Example 9 | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-189646 filed Sep. 28, 2015, which is hereby incorporated by reference wherein in its entirety.

What is claimed is:

1. A method of manufacturing a liquid ejection head in which an orifice plate having an ejection opening for ejecting liquid and a flow path communicating with the ejection opening is formed on a surface of a substrate, comprising:
a first step of forming, on the surface of the substrate, a mold unit for forming the flow path and a plurality of base units including a base unit adjacent to the mold unit, and
a second step of forming, on the surface of the substrate, a covering resin layer for forming the orifice plate by applying liquid-like resin composition so as to cover the surface of the mold unit and the surface of the base unit,
in a case where in a direction parallel to the surface of the substrate, an interval between one end of the base unit and the mold unit adjacent thereto is δ1, the interval of the plurality of base units is δ2, a distance between the center of the ejection opening and the other end of the base unit is L, in a case where in a direction vertical to the surface of the substrate, the height of the unevenness caused between the surface of the base unit and the surface of the mold unit is ΔH, and a thickness of the covering resin layer is H2,
when the base unit is formed so that δ2≦30 μm is established, the base unit and the covering resin layer are formed so that the relations δ1≦30 μm and ΔH=0 μm or H2/ΔH≧3 are satisfied and,
when the base unit is formed so that δ2>30 μm is established, the base unit and the covering resin layer are formed so that the relations δ1≦30 μm, L≧300 μm and H=0 μm or H2/ΔH≧3 are satisfied.

2. The method of manufacturing a liquid ejection head according to claim 1, wherein the first step forms, on the surface of the substrate, a plurality of mold units functioning as a mold for forming the flow path and two divided base units between the two neighboring mold units.

3. The method of manufacturing a liquid ejection head according to claim 1, wherein the base unit and the mold unit are formed to have the same thickness.

4. The method of manufacturing a liquid ejection head according to claim 2, wherein the divided base units formed between the mold units are formed to have different thicknesses, respectively.

5. The method of manufacturing a liquid ejection head according to claim 1, wherein a plurality of ejection opening arrays each consisting of a plurality of the ejection openings are formed and a penetration portion penetrating the covering resin layer is formed between the ejection opening arrays.

6. The method of manufacturing a liquid ejection head according to claim 1, wherein prior to the formation of the mold unit, an adhesion layer is formed on at least the surface of the substrate.

7. The method of manufacturing a liquid ejection head according to claim 1, wherein the base unit and the covering resin layer are formed by negative photosensitive resins, respectively, each of the negative photosensitive resins including a similar constituent material and differing only in the solvent amount.

8. The method of manufacturing a liquid ejection head according to claim 1, wherein the first step forms a first pattern consisting of resin on the surface of the substrate to thereby form the mold unit and then forms the second pattern consisting of resin on the surface of the substrate to thereby form the base unit.

9. The method of manufacturing a liquid ejection head according to claim 1, wherein the first step forms the mold unit and the base unit by forming a first pattern consisting of resin on the surface of the substrate.

10. The method of manufacturing a liquid ejection head according to claim 2, wherein the mold unit and the base unit are formed to have the same thickness.

11. The method of manufacturing a liquid ejection head according to claim 1, wherein the divided base units formed between the mold units are formed to have different thicknesses, respectively.

12. The method of manufacturing a liquid ejection head according to claim 2, wherein a plurality of ejection opening arrays each consists a plurality of the ejection openings are formed and a penetration portion penetrating the covering resin layer is formed between the ejection opening arrays.

13. The method of manufacturing a liquid ejection head according to claim 2, wherein prior to the formation of the mold unit, an adhesion layer is formed on at least the surface of the substrate.

14. The method of manufacturing a liquid ejection head according to claim 2, wherein the base unit and the covering resin layer are formed by negative photosensitive resins, respectively, each of the negative photosensitive resins including a similar constituent material and differing only in the solvent amount.

15. The method of manufacturing a liquid ejection head according to claim 2, wherein the first step forms a first pattern consisting of resin on the surface of the substrate to thereby form the mold unit and then forms the second pattern consisting of resin on the surface of the substrate to thereby form the base unit.

16. The method of manufacturing a liquid ejection head according to claim 2, wherein the first step forms the mold unit and the base unit by forming a first pattern consisting of resin on the surface of the substrate.
